(19) United States
(12) Patent Application Publication
(10) Pub. No.: US 2017/0238402 A1
(43) Pub. Date: Aug. 17, 2017

(54) METHOD FOR OPERATING A DISCHARGE LAMP OF A PROJECTION ARRANGEMENT AND PROJECTION ARRANGEMENT

(71) Applicant: OSRAM GmbH, Munich (DE)

(72) Inventors: Norbert Magg, Berlin (DE); Yu Ching Chen, Taipei (TW); Yu Wen Song, Taipei (TW)

(21) Appl. No.: 15/518,501

(22) PCT Filed: Sep. 29, 2015
(86) PCT No.: PCT/EP2015/072341

§ 371 Date: Apr. 12, 2017

(30) Foreign Application Priority Data
Oct. 14, 2014 (DE) 10 2014 220 780.0

(51) Int. Cl. H05B 41/39; G03B 21/20

(52) U.S. Cl. CPC H05B 41/39; G03B 21/2026; G03B 21/2053

(57) ABSTRACT

According to the present disclosure, a method for operating a discharge lamp of a projection arrangement is provided. The method includes storing the first commutation scheme in the ballast, such that the first commutation scheme fulfils a specification with respect to a first criterion, wherein the first criterion represents an electrode burnback; storing of the second commutation scheme in the ballast, such that the second commutation scheme fulfils a specification with respect to a second criterion; and operation of the discharge lamp with the alternation of the first and the second commutation schemes; characterized in that, a periodic brightness fluctuation in the discharge lamp is employed as the second criterion.

### RELATED APPLICATIONS

The present application is a national stage entry according to 35 U.S.C. §371 of PCT application No.: PCT/EP2015/072341 filed on Sep. 29, 2015, which claims priority from German application No.: 10 2014 220 780.0 filed on Oct. 14, 2014, and is incorporated herein by reference in its entirety.

### TECHNICAL FIELD

The present disclosure relates to a method for operating a discharge lamp of a projection arrangement, wherein the projection arrangement includes a predefined rotatable color wheel and the discharge lamp for the illumination of the color wheel, wherein the discharge lamp has two electrodes, wherein the projection arrangement has a ballast for the discharge lamp, which ballast provides a lamp current, configured as an alternating current, having at least one first waveform when the projection arrangement of the discharge lamp is operated, said waveform having a first definable commutation scheme, which is described by a first commutation vector, and a second definable waveform having a second definable commutation scheme, which is described by a second commutation vector, wherein each commutation vector has a binary value for each position defined by the color wheel as a potential point of current commutation, such that a polarity of the electrodes is commutated in accordance with the respective commutation scheme, including the following steps: a) storing of the first commutation scheme in the ballast, such that the first commutation scheme fulfils a specification with respect to a first criterion, wherein the first criterion represents an electrode burnback; b) storing of the second commutation scheme in the ballast, such that the second commutation scheme fulfils a specification with respect to a second criterion; and c) operation of the discharge lamp with the alternation of the first and the second commutation schemes. The present disclosure moreover relates to a corresponding projection arrangement.

### BACKGROUND

In recent years, the service life of high-pressure mercury lamps, for example the OSRAM P-VIP, has been significantly increased by improvements in the waveform design of the lamp current employed for the operation thereof. In this connection, a new generation of waveforms is known, for example, from DE 10 2011 089 592 A1, which are described as asymmetrical waveforms, and which have positive impacts upon the development and stabilization of the electrode tips. This is achieved by means of a well-dimensioned frequency modulation of the lamp current. A DLP projector for the projection of at least one image onto a projection surface, described in the aforementioned publication, thus includes at least one discharge lamp, a color wheel with a definable number of color segments, and a control device for the control of the discharge lamp. The control device is designed to control the discharge lamp such that the at least one image, with a definable refresh rate, is projected onto the projection surface. To this end, the control device controls the discharge lamp with a current waveform which incorporates at least one current ramp-up for the generation of a maintenance pulse. The current waveform, for its part, includes at least a first region, to which a first frequency f₁ is assigned, and a second region, to which a second frequency f₂ is assigned. The first region is determined by a first commutation, and by a second commutation, which follows thereafter. The second region is determined by the region between a second commutation and a first commutation, which follows thereafter. The first frequency f₁ is calculated by: f₁=1/(2*T1), where T1 is the time interval between the first and second commutations. The second frequency f₂ is calculated by:

$${f}_{2} = n \text{/} ( 2 * {\sum }_{i = 1}^{n} {T}_{i} ) ,$$

where Tᵢ represents the time intervals from one commutation to the next commutation within the second region, and n is the number of such time intervals within the second region. A modulation factor is defined by the relationship of the second frequency f₂ to the first frequency f₁. From this publication, it proceeds that the aforementioned advantageous effects in respect of electrode burnback are evident when the modulation factor is at least 3, and no greater than 8. The average frequency of the first and second frequencies lies between 30 Hz and 270 Hz, and advantageously between 45 Hz and 180 Hz.

In the operation of discharge lamps with asymmetrical waveforms, however, a new type of disturbance has been identified, described hereinafter as “scintillations”. From the subsequently published European patent application 13185019.0, it proceeds that these are periodic fluctuations in the brightness of the discharge lamp, which are attributable to a variation in the configuration of the discharge arc, specifically in the region of origin of the arc on the respective electrodes, in the cathode phase on the one hand, and in the anode phase on the other. The issue of scintillation arises, for example, if the repetition frequency of a specific segment of the waveform employed lies within a frequency range which is disturbing to the eye. Accordingly, this signifies the frequency at which a specific segment, for example a prominent white segment defined by the current profile, switches from the anode phase to the cathode phase, and back to the anode phase of a first electrode.

As the average frequencies, as indicated above, lie within a range which can be followed by the eye, or to which the receptors of the eye are sensitive, these periodic fluctuations in brightness are perceived as disturbing. Scintillations are particularly clearly detectable at low currents, i.e. in a discharge lamp which has already completed a prolonged period of service, i.e. an old discharge lamp, or during operation in dimmed mode.

In order to prevent this unwanted effect, the employment of an “integrator rod” is known from the prior art. This is, for example, a hollow body of metal construction, which is internally reflective. An integrator rod of this type permits the intermixing of light from the anode phase and the cathode phase. The aforementioned unwanted effects can be reduced as a result. However, if a short, cost-effective integrator rod is employed, strong periodic fluctuations in brightness, i.e. scintillations, will persist. Integrator rods which are dimensioned for the elimination or minimization of periodic fluctuations in brightness, however, are cost-intensive, and also require a larger installation space. These are both undesirable, in consequence of which integrator rods do not constitute a genuine option.

Another potential approach involves increasing the aforementioned frequency to ranges which can no longer be perceived by the human eye. However, this has an accompanying disadvantage, in that the aforementioned unwanted effect also impacts upon the development and stabilization of the electrode tips.

Electrode burnback, for example, can be undesirably high as a result of a strong back reflection of light from the color wheel, which results in the additional heat-up of the electrodes.

A generic method or a generic projection arrangement is known from U.S. Pat. No. 7,023,144 B2. Herein, the high-pressure discharge lamp is operated in an alternating manner at a service frequency between 60 Hz and 1,000 Hz, and at a low frequency between 5 Hz and 50 Hz. Insertion of the lower service frequency corresponds to at least one half-period and a maximum of five periods of the low-frequency alternating current which, by conversion, corresponds to a time interval between 1 s and 120 s. A low-frequency phase is thus deployed after a predefined duration of operation at the service frequency, in a constantly repeating pattern. The sequence of these two different types of operation is subject to strict timing.

The purpose of this operating method is the prevention of “flicker”. Flicker involves erratic fluctuations in brightness associated with known and conventional arcing surges. Such erratic fluctuations in brightness occur in a random manner, i.e. at varying frequencies. In consequence, they are not periodic. This is due to the fact that, during operation at the service frequency, stray electrode tips develop on the electrodes, with the result that the point of origin of arcing occurs on an electrode in a random and unforeseeable manner.

By the operating method proposed in the aforementioned document U.S. Pat. No. 7,023,144 B2, unwanted secondary tips are melted away during low-frequency phases, such that only a primary tip remains. The occurrence of any flicker of this type can thus be reliably prevented.

With further respect to the prior art, low-frequency insertions are also known from U.S. Pat. No. 6,670,780 B2, the purpose of which is the prevention of excessive tip development by the deliberate melt-back of tips.

### SUMMARY

The object of the present disclosure is thus the further development of a generic method or a generic projection arrangement, such that requirements for both a long service life and scintillation-free representation, i.e. the representation of projected images with no periodic fluctuations in brightness, in the interests of maximum satisfaction, are fulfilled in a cost-effective manner.

This object is fulfilled by a method having the characteristics of patent claim 1, and by a projection arrangement having the characteristics of patent claim 16.

The present disclosure is based upon the knowledge, from the subsequently published and aforementioned European patent application 13185019.0, to the effect that forms of operation are known which deliver scintillation-free service, i.e. the representation of projected images with no periodic fluctuations in brightness. According to this method, however, expectations for service life are undesirably low.

The present disclosure pursues a method whereby the discharge lamp is operated with the alternation of the first and the second commutation schemes, wherein the first commutation scheme is designed to fulfil a definable criterion with respect to electrode burnback, wherein the second commutation scheme is designed to fulfil a specification with respect to a second criterion, wherein the second criterion relates to a periodic brightness fluctuation, i.e. scintillations, in the discharge lamp.

As the two different types of service are executed in an alternating manner, it is possible to achieve a desired compromise between service life and the absence of scintillation, which has not been possible by the known method.

Investigations have revealed, however, that operating methods known from the prior art, i.e. waveforms which are associated with reduced electrode burnback, typically result in periodic brightness fluctuations. Conversely, waveforms which permit scintillation-free operation are typically associated with increased electrode burnback.

In principle, by the solution according to the present disclosure, an option is provided, as required—and as described in greater detail hereinafter—for the achievement of an appropriate compromise between reduced electrode burnback and operation which, insofar as possible, is scintillation-free.

A preferred form of embodiment is characterized by the following further steps: d) determination of at least one operating parameter for the discharge lamp, and e) setting of a time ratio between operation in accordance with the first commutation scheme and operation in accordance with the second commutation scheme, in relation to the operating parameter determined.

As investigations have revealed, electrode burnback assumes a dominant role at high lamp currents, i.e. at low arc voltages or at high rates of power conversion in the discharge lamp. Conversely, scintillations assume a significant role at low currents, i.e. at high arc voltages or at low rates of power conversion in the discharge lamp. Accordingly, this form of embodiment permits the identification of an optimum compromise between low electrode burnback and the absence of scintillation, in a targeted manner and for a specific discharge lamp in its current state.

If, for example, the average lamp current is employed as an operating parameter, it can be provided that, at an average lamp current below a definable threshold value, the proportion of operation in accordance with the second commutation scheme is predominant whereas, at an average lamp current which exceeds the definable threshold value, the proportion of operation in accordance with the first commutation scheme is predominant. Given that, in consideration of the operating parameter determined, the time ratio is set between operation in accordance with the first and second commutation schemes, near-optimum values can be achieved for both electrode burnback and the absence of scintillation.

As already indicated, the average arc voltage and/or the average power conversion of the discharge lamp can also be employed as operating parameters.

Advantageously, the first commutation scheme is selected such that the lamp arc voltage associated with operation according to the first commutation scheme, over a definable time interval, does not increase by more than 0.05 V/h, and advantageously by no more than 0.01 V/h. Commutation schemes of this type are known from the prior art wherein, for example, reference may be made to the aforementioned DE 10 2011 089 592 A1.

The first commutation scheme is advantageously selected such that a lamp current can be delivered at a frequency between 30 Hz and 300 Hz, specifically at a frequency between 45 Hz and 150 Hz. In this connection, an asymmetrical commutation scheme is advantageously selected as the first commutation scheme, specifically a commutation scheme with a frequency modulation factor of ≧3 and ≦8. For the definition of the frequency modulation factor, reference is made to the aforementioned embodiments cited with regard to the aforementioned DE 10 2011 089 592 A1.

The second commutation scheme is advantageously selected such that operation with the second commutation scheme reduces periodic fluctuations in brightness, specifically in comparison with operation according to the selected first commutation scheme. Advantageously, a symmetrical commutation scheme is selected as the second commutation scheme, particularly advantageously with an even number of commutations, in relation to the image refresh rate of the projection arrangement. Prior to the investigations conducted in conjunction with the aforementioned European patent application 13185019.0, it was not previously known that commutation schemes of this type are associated with a reduction in periodic brightness fluctuations.

Advantageously, the second commutation scheme is selected such that the time within which a first electrode, which is set to a first polarity and a first color segment, is switched to a second polarity and switched back again to the first polarity and the first color segment, is ≦20 ms, corresponding to a minimum repetition frequency of 50 Hz.

Symmetrical commutation schemes are characterized in that the anode phase and the cathode phase of a first electrode are of equal length in all cases. In asymmetrical commutation schemes, the anode and cathode phases of a first electrode are of different lengths. In order to prevent the formation of any DC fraction in the center, the electrodes alternate in their function as anode or cathode on a continuous basis.

Alternation of the first and second commutation schemes can proceed statically, i.e. following a definable number of periods of operation with the first commutation scheme, operation then ensues with the second commutation scheme for a second definable number of periods. However, alternation can also vary dynamically, specifically stochastically or erratically varied. It is particularly advantageous if the variation proceeds such that, after a definable time, the set time ratio between operation according to the first commutation scheme and operation according to the second commutation scheme is achieved. Specifically, the dynamic alternation of the two commutation schemes, as a result of the irregularity thus introduced, generates a further reduction in periodic brightness fluctuations. In respect of its positive effects, this form of embodiment is clearly superior to static alternation only. Specifically, it provides an option for the significant reduction of electrode burnback, in comparison with static alternation, with comparable scintillations.

The variation in the time ratio between operation according to the first commutation scheme and operation according to the second commutation scheme, in accordance with the operating parameter determined, can be linearly dependent upon the respective operating parameter, but can also incorporate other characteristics, depending upon which of the two phenomena, i.e. electrode burnback or the absence of scintillations, is of greater significance in the specific customer application or in the light of the current state of the discharge lamp.

For example, the variation can also be executed non-linearly, in particular in accordance with a quadratic and/or exponential and/or radical and/or logarithmic relationship.

Further preferred forms of embodiment proceed from the sub-claims.

The preferred forms of embodiment disclosed with reference to the method according to the present disclosure, and the advantages thereof, shall apply correspondingly, insofar as applicable, to the projection arrangement according to the present disclosure.

### BRIEF DESCRIPTION OF THE DRAWING(S)

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic representation of a projection arrangement according to the present disclosure;

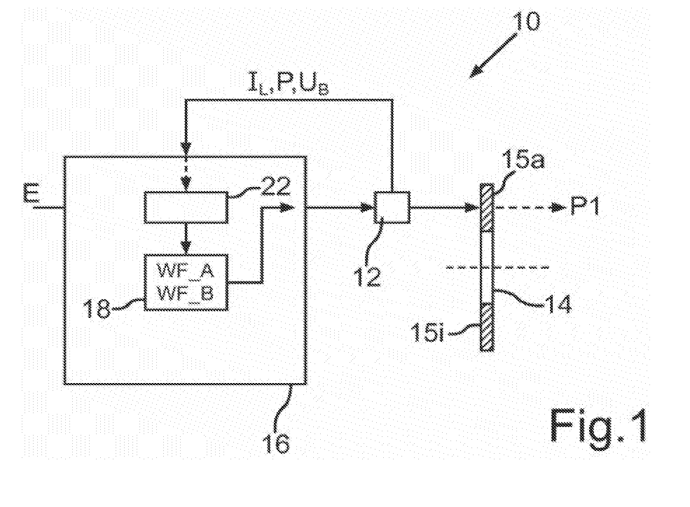

FIG. 2 shows a schematic representation of the setting of a time ratio between operation according to a first commutation scheme (KS_B) and operation according to a second commutation scheme (KS_A), in relation to the average arc voltage or the average lamp current;

FIG. 3 shows a schematic representation of examples of the time characteristic of a lamp current according to a waveform (WF_A), which generates limited scintillations, and according to a waveform (WF_B) which results in limited electrode burnback; and

FIG. 4 shows an embodiment of a static alternation of the two waveforms (FIG. 4a)), and a randomized variation (FIG. 4b)).

### DETAILED DESCRIPTION

A projection arrangement 10 according to the present disclosure includes a predefined rotatable color wheel 14 with filter segments 15a, 15i, by means of which the required color fractions are filtered out of the light emitted by a white light source 12, specifically a high-pressure discharge lamp, using color filters. The discharge lamp 12 has two electrodes, which are not represented in greater detail. The projection arrangement 10 moreover includes a ballast 16 for the discharge lamp 12, which ballast provides a lamp current, configured as an alternating current, having at least one first waveform WF_B when the projection arrangement 10 of the discharge lamp 12 is operated, said waveform having a first definable commutation scheme KS_B, which is described by a first commutation vector, and a second definable waveform WF_A having a second definable commutation scheme KS_A, which is described by a second commutation vector. Each commutation vector has a binary value for each position defined by the color wheel 14 as a potential point of current commutation, such that a polarity of the electrodes is commutated in accordance with the respective commutation scheme.

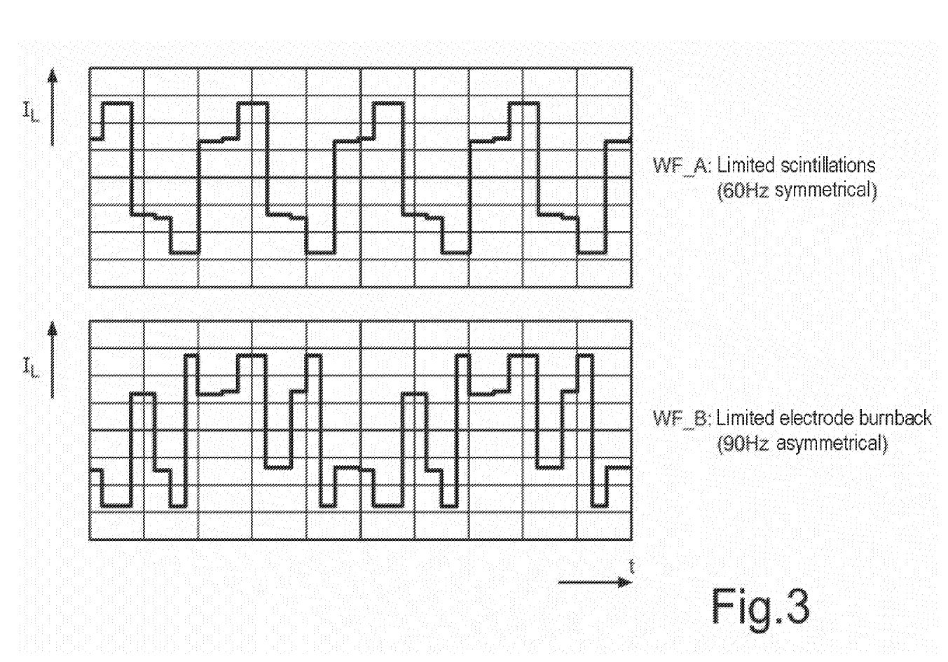

The first commutation scheme KS_B and the second commutation scheme KS_A are stored in a memory 18 of the ballast 16. The first commutation scheme KS_B, which generates the waveform WF_B, is configured such that said scheme produces a limited electrode burnback. The second commutation scheme KS_A is configured such that the waveform resulting therefrom generates limited scintillations, i.e. limited periodic brightness fluctuations in the discharge lamp. Exemplary waveforms are described in greater detail hereinafter, with reference to FIG. 3.

According to the present disclosure, the discharge lamp 12 essentially operates alternately with the first waveform WF_B and the second waveform WF_A.

The ballast 16 has an input E for the infeed of the image content to be projected. The ballast 16 includes a device 22 for the determination of an operating parameter of the discharge lamp 12. Specifically, the average lamp current IL, the average arc voltage U_{B}, and the average power P converted in the discharge lamp 12 are considered for this purpose. The ballast 16 is designed to set a time ratio between operation according to the first commutation scheme KS_B and operation according to the second commutation scheme KS_A, in relation to the operating parameter determined. Specifically, an operating parameter is to be determined which permits the establishment of a reliable conclusion in respect of, firstly, the situation regarding electrode burnback, and secondly the situation regarding the risk of periodic brightness fluctuations.

In this regard, the ballast 16 can be designed such that the power delivered to the discharge lamp 12 is set to a constant value, for example 300 W. The arc voltage U_{B} is critically dependent upon the clearance between the electrodes in the discharge lamp 12, and upon the internal pressure in the discharge chamber of the discharge lamp 12. In principle, in the light of easier measurability during the operation of the discharge lamp at rated capacity, evaluation of the arc voltage U_{B} as the operating parameter is recommended accordingly.

In an optional dimmed mode, it can be provided that the ballast 16 is designed to deliver reduced power to the discharge lamp in relation to the rated capacity, e.g. in the aforementioned example 250 W rather than 300 W. In this case, however, according to a first approximation, the arc voltage U_{B} remains the same. Accordingly, this parameter does not reflect the increased risk of periodic brightness fluctuations. In dimmed operation, however, the average lamp current IL is subject to change. In this case, evaluation of the lamp current IL as the operating parameter is therefore more strongly recommended.

Although the setting of the time ratio in relation to the instantaneous value of at least one operating parameter is particularly advantageous, the static setting of a fixed ratio delivers sufficient advantages in relation to the prior art, in specific applications. The determination and evaluation of at least one operating parameter, and the setting of the time ratio between operation according to the first (KS_B) and the second commutation scheme KS_A, in relation to the at least one operating parameter determined, can then be omitted.

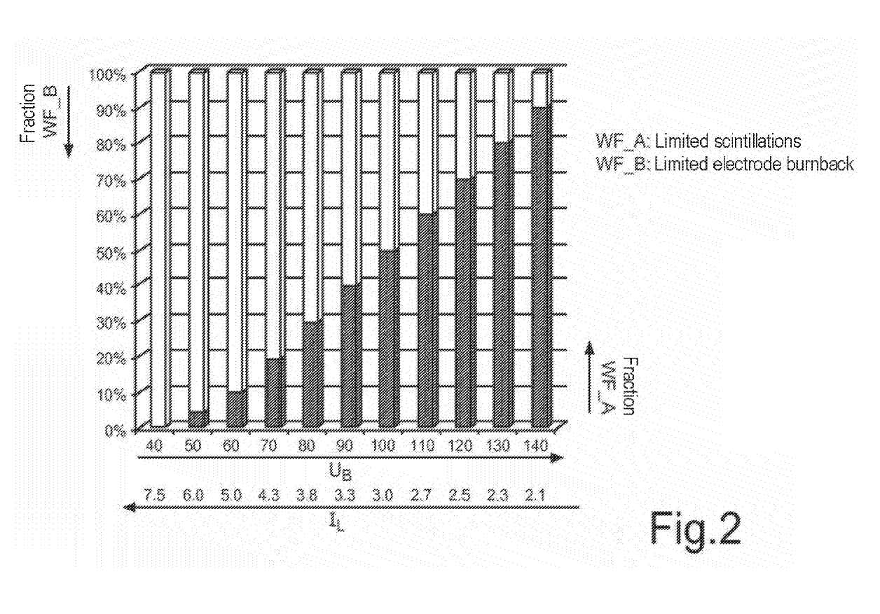

Regarding the setting of the ratio in relation to the at least one operating parameter, reference is made to FIG. 2 which shows that, as the arc voltage U_{B} rises, the percentage fraction of the time ratio during which operation is executed with the waveform WF_A increases. Correspondingly, the fraction of operation with the waveform WF_B decreases. For example, in the exemplary embodiment with an arc voltage U_{B} of 120 V, the fraction of WF_A is 68% and the fraction of WF_B is 32%. A decline in the arc voltage U_{B} is associated with a rise in the lamp current IL wherein, at a high lamp current IL, the preferred fraction of WF_A is low and the preferred fraction of WF_B is high. Below an average lamp current IL of approximately 3 A (in the exemplary embodiment), the fraction of WF_B is predominant whereas, above this threshold value, the fraction of WF_A is predominant.

At a lamp current IL of, for example, 4.3 A, which corresponds to an arc voltage U_{B} of 70 V in the embodiment, the fraction of WF_A is approximately 18%, whereas the fraction of WF_B, correspondingly, is approximately 82%.

FIG. 3 shows an exemplary time characteristic of the lamp current IL for a waveform WF_A which generates limited scintillations, and for a waveform WF_B which is associated with limited electrode burnback. Accordingly, in the embodiment, the waveform WF_A is based upon a symmetrical commutation scheme, in the present case with a frequency of 60 Hz. In the embodiment, the waveform WF_B is based upon an asymmetrical commutation scheme, in the present case with a frequency of 90 Hz. Naturally, both waveforms WF_A, WF_B are designed for operation with one and the same color wheel 14.

In general, the first commutation scheme KS_B is selected such that the lamp arc voltage U_{B} during operation with the first commutation scheme KS_B over a definable time interval, for example five hours, does not rise by more than 0.05 V/h, and advantageously by no more than 0.01 V/h. Specifically, this scheme is selected such that a lamp current IL with a frequency between 30 Hz and 300 Hz, and specifically with a frequency between 45 Hz and 150 Hz, can be delivered. An asymmetrical commutation scheme is specifically preferred, wherein asymmetrical commutation schemes with a frequency modulation factor of ≧3 and ≦8, as described heretofore, are predominantly employed.

The second commutation scheme KS_A employed in the present disclosure is characterized in that, during operation with the second commutation scheme KS_A, periodic brightness fluctuations are reduced, specifically in comparison with operation according to the first commutation scheme KS_B. A measure of periodic brightness fluctuations associated with a specific commutation scheme can be simply established by the measurement of the time characteristic for brightness at the location of the projection screen, for example the measurement of light intensity using a lux meter.

The second commutation scheme KS_A is advantageously a symmetrical commutation scheme, advantageously with an even number of commutations in relation to the image refresh rate of the projection arrangement 10. In this connection, second commutation schemes KS_A are in particular selected such that the time within which one electrode, which is set to a first polarity and a first color segment, switches to a second polarity and back again to the first polarity and the first color segment, is ≦20 ms, corresponding to a minimum repetition frequency of 50 Hz.

The variation between the commutation schemes, i.e. between operation with the first waveform WF_B and operation with the second waveform WF_A, can be executed statically. However, this variation can also be executed dynamically and, specifically, randomly. In the last-mentioned embodiment, variation can proceed such that, after a definable time, the set time ratio between operation according to the first commutation scheme KS_B and operation according to the second commutation scheme KS_A is achieved. Further examples of first commutation scheme KS_B can be obtained, for example, from DE 10 2011 089 592 A1, c.f. FIG. 5 therein.

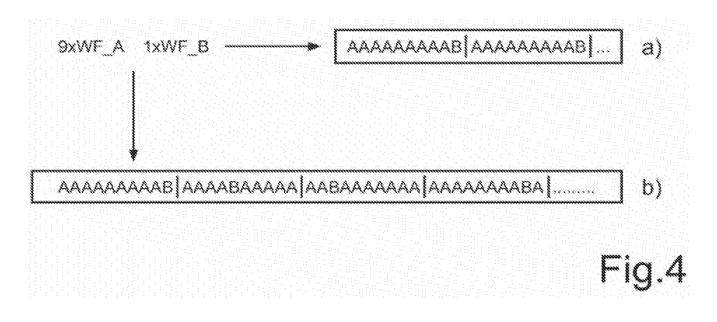

FIG. 4 shows an embodiment, wherein a ratio of 90% WF_A to 10% WF_B is to be achieved. The basic unit considered is advantageously a multiple of one frame or one rotation of the color wheel. According to FIG. 4a, variation is executed statically, i.e. every nine units of WF_A are followed by one unit of WF_B. In the sequence represented in FIG. 4b, variation is executed stochastically or erratically such that, after a definable time, the set time ratio, in this case of 90 to 10, is achieved. At an image repetition frequency of, for example 60 Hz, the setting of the required ratio thus involves nine units of WF_A of respective duration 16.67 ms to one unit of WF_B of duration 16.67 ms.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A method for operating a discharge lamp of a projection arrangement, wherein the projection arrangement comprises a predefined rotatable color wheel and the discharge lamp for the illumination of the color wheel, wherein the discharge lamp has two electrodes, wherein the projection arrangement has a ballast for the discharge lamp, which ballast provides a lamp current, configured as an alternating current, having at least one first waveform when the projection arrangement of the discharge lamp is operated, the waveform having a first definable commutation scheme, which is described by a first commutation vector, and a second definable waveform having a second definable commutation scheme, which is described by a second commutation vector, wherein each commutation vector has a binary value for each position defined by the color wheel as a potential point of current commutation, such that a polarity of the electrodes is commutated in accordance with the respective commutation scheme;
the method comprising:
storing the first commutation scheme in the ballast, such that the first commutation scheme fulfils a specification with respect to a first criterion, wherein the first criterion represents an electrode burnback;
storing the second commutation scheme in the ballast, such that the second commutation scheme fulfils a specification with respect to a second criterion; and
operating the discharge lamp with the alternation of the first and the second commutation schemes;
wherein a periodic brightness fluctuation in the discharge lamp is employed as the second criterion.

2. The method as claimed in claim 1,
further comprising,
determining at least one operating parameter for the discharge lamp; and
setting a time ratio between operation in accordance with the first commutation scheme and operation in accordance with the second commutation scheme, in relation to the operating parameter determined.

3. The method as claimed in claim 2,
wherein the average lamp current is employed as an operating parameter.

4. The method as claimed in claim 3,
wherein at an average lamp current below a definable threshold value, the proportion of operation in accordance with the second commutation scheme is predominant whereas, at an average lamp current which exceeds the definable threshold value, the proportion of operation in accordance with the first commutation scheme is predominant.

5. The method as claimed in claim 2,
wherein the average arc voltage is employed as an operating parameter.

6. The method as claimed in claim 2,
wherein the average power conversion of the discharge lamp is employed as an operating parameter.

7. The method as claimed in claim 5,
wherein the first commutation scheme is selected such that the lamp arc voltage associated with operation according to the first commutation scheme, over a definable time interval, does not increase by more than 0.05 V/h.

8. The method as claimed in claim 1,
wherein the first commutation scheme is selected such that a lamp current can be delivered at a frequency between 30 Hz and 300 Hz.

9. The method as claimed in claim 8,
wherein an asymmetrical commutation scheme is selected as the first commutation scheme.

10. The method as claimed in claim 1,
wherein the second commutation scheme is selected such that operation with the second commutation scheme reduces periodic fluctuations in brightness.

11. The method as claimed in claim 10,
wherein a symmetrical commutation scheme is selected as the second commutation scheme in relation to the image refresh rate of the projection arrangement.

12. The method as claimed in claim 1,
wherein the second commutation scheme is selected such that the time within which a first electrode, which is set to a first polarity and a first color segment, is switched to a second polarity and switched back again to the first polarity and the first color segment, is equal to or lower than 20 ms, corresponding to a minimum repetition frequency of 50 Hz.

13. The method as claimed in claim 1,
wherein alternation proceeds statically.

14. The method as claimed in claim 1,
wherein alternation varies dynamically.

15. The method as claimed in claim 14
wherein variation proceeds such that, after a definable time, the set time ratio between operation according to the first commutation scheme and operation according to the second commutation scheme is achieved.

16. A projection arrangement having a predefined rotatable color wheel and a discharge lamp for the illumination of the color wheel, wherein the discharge lamp has two electrodes, wherein the projection arrangement has a ballast for the discharge lamp, which ballast can provide a lamp current, configured as an alternating current, having at least one first waveform when the projection arrangement of the discharge lamp is operated, the waveform having a first definable commutation scheme, which can be described by a first commutation vector, and a second definable waveform having a second definable commutation scheme, which can be described by a second commutation vector, wherein each commutation vector has a binary value for each position defined by the color wheel as a potential point of current commutation, such that a polarity of the electrodes is commutatable in accordance with the respective commutation scheme, wherein the projection arrangement has a memory device in which the first commutation scheme and the second commutation scheme are stored, wherein the first commutation scheme fulfils a specification with respect to a first criterion, wherein the first criterion represents an electrode burnback, wherein the second commutation scheme fulfils a specification with respect to a second criterion, wherein the ballast is designed for the alternating operation of the discharge lamp according to the first and the second commutation schemes,
wherein the second criterion represents a periodic brightness fluctuation in the discharge lamp.

17. The method as claimed in claim 5, wherein the first commutation scheme is selected such that the lamp arc voltage associated with operation according to the first commutation scheme, over a definable time interval, does not increase by no more than 0.01 V/h.

18. The method as claimed in claim 1, wherein the first commutation scheme is selected such that a lamp current can be delivered at a frequency between 45 Hz and 150 Hz.

19. The method as claimed in claim 9, wherein the asymmetrical commutation scheme has a frequency modulation factor equal to or greater than 3, and equal to or lower than 8.

20. The method as claimed in claim 1, wherein alternation varies stochastically or erratically.
